(19) United States
(12) Patent Application Publication
(10) Pub. No.: US 2006/0024142 A1
(43) Pub. Date: Feb. 2, 2006

(54) Torque-limiting stud

(76) Inventor: Lucien C. Ducret, Stamford, CT (US)

Correspondence Address: YURI KATESHOV, 174 FERNDALE ROAD, SCARSDALE, NY, 10583, US

(21) Appl. No.: 10/909,944

(22) Filed: Aug. 2, 2004

(51) Int. Cl. F16B 31/00

(52) U.S. Cl. 411/7

(57) ABSTRACT

A torque-limiting structure includes a sleeve coupled to a stud so that one of the stud and sleeve has a ramp provided with a spirally raised resilient free end. The free end is configured to rotatably couple the sleeve and shank in response to applying an initial torque and to allow the sleeve to slip relative to the shank in response to applying a limiting torque, which is greater than the initial torque.

### BACKGROUND OF THE INVENTION

1. Field of the Invention

The invention generally relates to fasteners. Particularly, the invention relates to studs provided with built-in torque-limiting features.

2. Related Prior Art

Numerous operations require that objects to be treated for various applications be initially placed and reliably held in the desired position. Often, tools performing a given operation on an object have a structure for reliably clamping this object between two or more tool components. Typically, one or more tool components are displaceable towards the object in response to applying an external force generated by the user. Displacement of the components continues until the object is secured.

The user relying on his/her experience typically determines reliable clamping of an object. It is not unusual, however, to apply an extra effort to ensure the desirable position of the clamped object regardless of whether this position has been already established or not.

For example, numerous cables have armored casings that are to be removed before connecting a cable in accordance with a given task. Cable cutting tools typically include a clamping arrangement, a so-called C-clamp, configured with a thumbscrew for securing the cable. In operation, the user applies a torque to a clamping stud displaceable towards and pressing against the cable. Often, after having secured the cable, the user may provide an additional torque to ensure reliable engagement between the stud and armored casing. Accordingly, the stud may advance further and crash the armored casing, which may lead to damaging the cable. Also, a body of cutting tools may experience undesirable reactive forces in response to unlimited torques, which potentially may damage the structural integrity of the tool's body.

Similar to clamping studs, tightening screws and bolts may require torque-limiting structures that prevent excessive external torques often damaging the body of this type of fasteners. In additional to protecting fasteners, a torque-limiting structure may provide control of applied torques. Characteristically, all the above-mentioned fasteners are known for being large and cumbersome.

A need therefore exists for studs provided with a torque-limiting structure operative to protect studs from overtightening.

A further need exists for studs provided with a torque-limiting structure operative to control applied torques.

Still a further need exists for studs with a built-in torque limiting structure that can be easily assembled and maintained.

Still another need exists for a method of making studs with built-in torque-limiting structures.

### SUMMARY OF THE INVENTION

The present invention is directed to studs and methods that satisfy these needs. The invention includes a method of making a torque-limiting stud. In response to an external torque applied to a sleeve, a shank starts rotating with the sleeve while moving along a generally linear path at a predetermined distance. Once the applied torque reaches a preset limit, the sleeve rotatably disengages the shank and stops transferring the limiting torque to the shank. Increasing the applied torque will be sufficient to rotationally actuate the sleeve, but not affect the shank after its disengagement from the sleeve.

The shank's head has a ramp frictionally engaging the sleeve with a force sufficient for the sleeve and shank to rotate together while moving the stud at a predetermined distance. The head has a resilient portion bent at a preset angle relative to an underlying surface of the head and pressing against the sleeve with a force preventing rotational disengagement between these component during their displacement at the predetermined distance. The preset angle is controllably selected to define a limiting torque. Upon reaching the limiting torque, the sleeve starts slipping along the ramp relative to the shank without further driving the shank that has advanced at the desired distance. The ramp is configured to allow the sleeve to rotate relative to the shank in one rotational sense corresponding to advancement of the stud in a tightening axial direction after the object has been tightened. The bent portion of the stud abuts the sleeve upon reversing the rotational sense allowing thus the sleeve to displace the stud in an opposite axial direction.

A torque-limiting stud configured in accordance with the invention includes a shank having on its proximal end a head. The head is configured with a ramp coupleable to a sleeve, which drives the shank to a desired position in response to a pre-limiting torque applied to the head. A key, coupled to the sleeve, frictionally engages and presses against the ramp with a friction force, which prevents rotation of the sleeve relative to the shank in response to the pre-limiting torque. As a result, the sleeve axially displaces the shank in an axial tightening direction. As the applied torque gradually increases reaching a preset value that is selected to overcome the friction force between the ramp and key, the key starts sliding relative to the ramp preventing thus further axial displacement of the shank.

Configuration of the ramp includes a bent portion spaced from an underlying surface of the head and resiliently urging against the key. Increasing the applied torque to the preset value forces the key to move along the ramp and deflect the bent portion towards the underlying surface of the head. The edge of the bent portion terminates at an angular distance from an opposite flank of the ramp. Accordingly, the ramp has a recess separating the flank and the edge of the bent portion and configured to receive the key once it has passed the bent portion.

Since the opposite flank is configured to allow further rotation of the key along the ramp, increasing the torque above the preset value results in rotation of the sleeve relative to the shank. Reverse direction of rotation will force the key to abut the edge of the bent portion for simultaneous rotation of the coupled shank and head associated with axial displacement of the shank in an axial direction opposite to the initial axial direction.

The inventive torque-limiting stud thus allows the user (a) to increase a torque without the risk of overtightening the stud, and (b) in certain applications, to apply the same torque to a plurality of studs for uniform tightening coupleable objects.

These and other features and aspects of the present invention will be better understood with reference to the following description, figures, and appended claims.

### BRIEF DESCRIPTION OF THE FIGURES

FIG. 1 illustrates an exploded view of a torque-limiting stud configured in accordance with the invention;

FIG. 2 illustrates an isometric view of the torque-limiting stud of FIG. 1;

FIG. 3 illustrates an axial section of the assembled torque-limiting stud of FIG. 2;

FIG. 4 illustrates an axial section of a shank of the torque-limiting stud of FIGS. 1-3 with a bent portion raised above an underlying surface when a pre-limiting torque is applied to the inventive stud; and

FIG. 5 illustrates an axial section of a shank of the torque-limiting stud of FIGS. 1-3 with a bent portion displaced toward an underlying portion in response to a limiting torque applied to the inventive stud.

### SPECIFIC DESCRIPTION OF THE INVENTION

Reference will now be made in detail to several views of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, proximal, distal, below and above may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

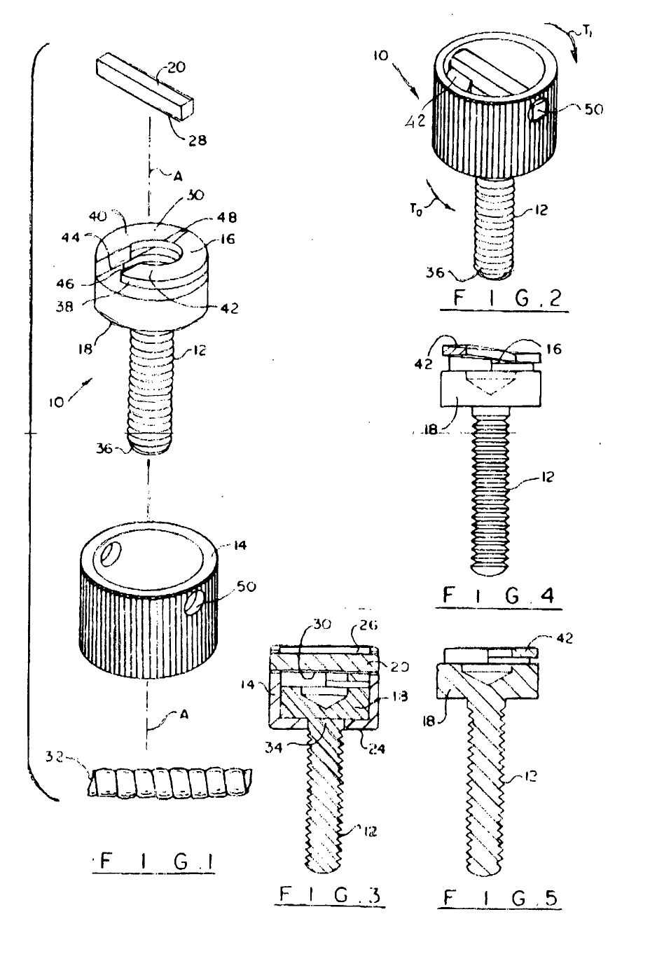

Referring to FIGS. 1-3, a torque-limiting stud 10 has a shank 12, a sleeve 14, configured with opposite open ends 24, 26 (FIG. 3) and a key 20 coupled to the sleeve 14. Assembling the stud 10 includes inserting the shank 12 through the sleeve 14, and further securing the key 20 to the sleeve 14 above the shank 12. All of the components are so dimensioned and shaped that, in the assembled state of the stud 10, an underside 28 of the key 20 (FIG. 1) presses upon a surface 30 (FIGS. 1, 3) of the shank 12. Friction between the key 20 and surface 30 is sufficient to allow the sleeve 14 to rotatably drive the shank 12 in response to an initial torque Ti (FIG. 2). As a result, the assembled stud 10 moves axially to either clamp an object 32 (FIG. 1), such as a cable, and/or couple separate objects depending on whether the stud 10 is a clamp, bolt or screw. Synchronous rotation of the sleeve 14 and shank 12 continues until a friction force generated by the clamped object and a distal end 36 of the shank 12 (FIGS. 1, 2) causes the user to apply a limiting torque sufficient to slip the sleeve 14 relative to the shank 12. Applying a torque To (FIG. 2), directed opposite to the initial tightening or clamping direction, causes the sleeve 14 and shank 12 engage again and rotate together thereby displacing the stud 10 axially away from the object 32.

A proximal end 34 (FIG. 3) of the shank 12 is configured with a head 18 nested within the sleeve 14 in the assembled state of the stud 10. The head 18 has a base surface 38 (FIG. 1) supporting a ramp 16, which defines the surface 30 (FIG. 3) contacting the side 28 of the key 20 (FIG. 1). The ramp 16 is configured as a continuos formation having a base 40 (FIG. 1) rigidly coupled to the base surface 38 and a resilient free end 42. Extending spirally from a flank 44 of the base 40, the ramp 16 is so configured that its resilient free end 42 is spaced from the base surface 38 and functions as a spring. Accordingly, selecting an angle at which the free end 42 is raised relative to the base surface 38 defines a pre-selected value of a limiting torque, at which the key 20, rotatably fixed to the sleeve 14, starts slipping relative to the ramp 16. The steeper the ramp 16, the greater the pre-selected value of the initial torque.

The ramp extends spirally around the axis A-A (FIG. 1) at an angle smaller than a 360° angle and defines a gap 46 shaped and dimensioned to receive a portion of the key 20 after the key has passed the free end 42 of the ramp 16, which is accompanied by a click. The cross-section of the key 20 may be circular or polygonal with a slanted leading edge cooperating with the flank 44 of the ramp 16, if the user continues to apply a torque at least equal to the limiting torque. The flank 44, in turn, also may be slanted to have its surface extending complementary to the leading edge of the key 20 to allow the key 20, located in the gap 46 (FIG. 1), to slidably engage and move relative to the ramp in response to the limiting torque. To rotatably fix the key 20 to the sleeve 14, the key may be wedged across the inner peripheral wall of the sleeve and have its opposite ends received in holes 50, which are open into a knurled outer surface of the sleeve (FIGS. 1, 2).

If the key 20 is located within the gap 46 (FIG. 1) and the user applies the torque To (FIG. 2), the key 20 will abut the free end 42 of the ramp 16 for further rotation of the stud 10 in a releasing direction opposite to the tightening direction. If the key 20 is located somewhere along the ramp 16 and the torque To is applied, a ledge 48 (FIG. 1) formed between the opposite ends of the ramp abuts the 20 key for simultaneous rotation of the sleeve 14 and shank 12 in the releasing direction. To ensure a long-lasting springing function of the free end 42 of the ramp 16, the free end is hardened by initially thermally treating it and subsequently quenching the free end, for example, in oil.

Note that the location of the key 20 and ramp 16 may be reversed; the shank 22 may be formed with the key, while the ramp may be rotatably fixed to the sleeve 14.

Referring to FIGS. 1, 3-5, upon applying the limiting torque, which causes the sleeve 14 to slip relative to the shank 12, the free end 42 of the ramp 16 is deflected axially towards the base surface 38 substantially to the level of the base 40 (FIGS. 3 and 5). If an unloaded state, the free end 42 is raised relative to the base 40, as illustrated by FIG. 4.

The specific features described herein may be used in some embodiments, but not in others, without departure from the spirit and scope of the invention as set forth. Many additional modifications are inteded in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is served by the claims and their equivalents.

1. A torque-limiting stud, comprising:
a head formed on one side with a shank and provided on an opposite side with a ramp extending spirally around an axis; and
a sleeve rotatable on the head and having a key riding on the ramp and driving the head until a limiting torque is reached at which the key slips relative to the ramp.

2. The torque-limiting stud of claim 1, wherein the ramp has a resilient free end spaced from an underlying surface of the head.

3. The torque-limiting stud of claim 2, wherein the free end has a preselected angle with the underlying surface set for the stud and defining the limiting torque.

4. The torque-limiting stud of claim 2, wherein the free end defines a gap with an opposing flank of the ramp, the gap being shaped and dimensioned to receive the key.

5. The torque-limiting stud of claim 4, wherein the ram has a ledge between the opposing flank and the free end engageable by the key upon application of a reverse torque directed opposite to the limiting torque for rotating the shank and sleeve away from the object in a releasing direction.

6. The torque-limiting stud of claim 4, wherein the free end is raised relative to the opposing flank of the ramp and abuts the free end of the ramp in response to a reverse torque, directed opposite to the limiting torque, for rotating the sleeve and shank in a releasing direction.

7. The torque-limiting stud of claim 4, wherein the opposing flank of the ramp and a leading edge of the key have complementary extending slanted surfaces cooperating to displace the key from the gap onto the ramp upon application of the limiting torque.

8. The torque-limiting stud of claim 1, wherein the key is wedged to an inner peripheral surface of the sleeve.

9. The torque-limiting stud of claim 1, wherein the key has a circular or polygonal cross-section

10. A torque-limiting stud, comprising:
a sleeve operative to rotate in opposite tightening and releasing directions;
a shank received within the sleeve; and
a coupling unit provided between the sleeve and shank and having a ramp, the ramp having a spirally extending resilient portion operative to rotationally couple the sleeve and shank in response to applying an initial torque in the tightening direction and rotationally decoupling the sleeve and shank in response to applying a limiting torque codirected with and greater than the initial torque.

11. The torque-limiting stud of claim 10, wherein the coupling unit includes a key couplable to one of the sleeve and shank, the ramp being formed on the other one of the sleeve and shank and having a surface slidably engaging the key in response to the limiting torque applied in the tightening direction so that the sleeve is displaceable relative to the shank, the surface of the ramp engaging the key in response to applying a torque in the releasing direction to rotatably fix the sleeve and shank.

12. The torque-limiting stud of claim 11, wherein the key is rotationally fixed to the ramp in response to applying the initial torque and operative to slip relative to the surface in response to applying the limiting torque.

13. The torque-limiting stud of claim 11, wherein the surface of the ramp has a raised free end defining the resilient portion of the ramp pressed upon the key.

14. The torque-limiting stud of claim 13, wherein the raised free end is raised at a preselected angle set for the stud and defining the limiting torque.

15. The torque-limiting stud of claim 14, wherein the ramp has a base potion spaced angularly from the raised free end to define a gap configured to receive a portion of the key so that the key is enabled to slide from the gap onto the ramp upon applying the limiting torque and to prevent the relative displacement between the key and ramp in the releasing direction.

16. A method of making a torque-limiting stud having a head formed on one side with a shank and provided on an opposite side with a ramp extending spirally around an axis; and a sleeve rotatable on the head and having a key riding on the ramp and driving the head until a limiting torque is reached at which the key slips relative to the ramp, the method comprising the steps of:
bending a free end of the ramp away from an underlying surface of the head to include an angle between the free end and the underlying surface;
fitting the cap onto the head from the one side; and
capturing the cap on the head by inserting the key into the cap on the opposite side.

17. The method of claim 16, further comprising hardening the free end to sustain a long-lasting resilience thereof.

18. The method of claim 17, wherein the hardening of the free end includes thermally treating the free end and quenching the thermally treated free end.

19. The method of claim 16, further comprising providing a gap formed on the ramp between the bent free end and a base portion of the ramp and configured to receive the key so that the key is operative to slip relative to the ramp in a tightening direction in response to applying the limiting torque and engage the free end for rotationally coupling the sleeve and shank in a releasing direction upon applying a reverse torque directed opposite to the limiting torque.

20. The method of claim 16, wherein the limiting torque is a function of the angle at which the free end is bent relative to the underlying surface.
